(19) United States
(12) Patent Application Publication
(10) Pub. No.: US 2021/0348727 A1
(43) Pub. Date: Nov. 11, 2021

(54) ILLUMINATED ANIMATED GRAPHIC IMAGE BAND

(71) Applicant: Lumi Enterprises Ltd., Minneapolis, MN (US)

(72) Inventor: Herbert B. Fick, Minneapolis, MN (US)

(21) Appl. No.: 17/308,866

(22) Filed: May 5, 2021

Related U.S. Application Data
(60) Provisional application No. 63/020,277, filed on May 5, 2020.

(51) Int. Cl. F21S 4/24; F21V 23/00; F21S 9/02; F21V 33/00

(52) U.S. Cl. CPC F21S 4/24; F21V 23/005; F21Y 2115/10; F21V 33/0008; F21S 9/02

(57) ABSTRACT

This Graphic Band Assembly includes a band/strap that may be worn and is printed with a graphic image made up of electroluminescent segments. The graphic image on the band/strap is animated by the programming of circuitry contained in underlying layers of the band/strap which causes the selective illumination of the segments. The Graphic Band Assembly includes a PCB control unit and a rechargeable battery that contain the illumination program, control the EL illumination pattern, and provide the power to illuminate the EL Band. The Assembly includes accessible switches that allow the unit to be turned on and off, and to switch between programs. The Assembly includes a USB port for recharging and programming the device.

### BACKGROUND

In many situations, illuminated and/or graphic images are fun, exciting, eye-catching and interesting. Consequently, the creation of flexible products capable of creating illuminated and/or graphic images allows for many applications including product promotions, advertising, team building, affinity group identity (or common interest group identity), and general excitement in many different contexts.

The creation and production of products capable of presenting or displaying the graphic images outlined above has complications however, including the ability to create the desired images in the required brightness, the ability to provide and manage needed power, and the ability to provide cost effective products. In some situations, including novelty and event-based sales, the intended price point for such products is relatively low. Thus, a cost effective yet efficient design is important.

### SUMMARY

In order to provide a product that is eye catching, interesting and capable of use in many situations, a power source, a PCB, and an electro-luminescent circuit is combined with a printed graphic image to create a display device that is wearable or portable (such as a band or strap), which can also provide brand/event advertising, team building, group identity, entertainment, safety, visibility, or excitement when activated. The design of each element, and combination creates a visual presentation that is eye catching and can be tailored for many different situations. Further, the printing approach used provides considerable flexibility, allowing for many unique designs and graphic presentations.

The embodiments of the invention described herein include a wristband format of the display device that animates using illumination, and is worn for promoting brand identity, entertainment, safety, pleasure, and/or generating excitement. That said, the concept described herein can be applied to many different products, including an ankle band, belt, dog collar, dog leash, pendant, key chain, lanyard, clothing accessory, etc.

### BRIEF DESCRIPTION OF THE DRAWINGS

Various details of the embodiments of the invention can be seen from the enclosed figures, which include:

FIG. 1 is an exploded view of an illuminated animated graphic wristband;

FIG. 2 presents a general block diagram of the circuitry used in the wristband of FIG. 1;

FIG. 3A-3DD illustrates one exemplary animation program made possible by the illuminated animated graphic wristband

FIG. 4 shows one embodiment of the display device layer stack-up; and

FIG. 5 illustrates the circuit layout for one exemplary display device.

### DESCRIPTION

As shown in the figures, one embodiment of a wristband is configured in a manner that allows it to be worn in various ways. It generally comprises a wrap-around Graphic Band that can be illuminated to create an animated pattern, scene, or design. Switches allow sections of the wristband to be turned on and off in a predetermined manner, and allows for a number of different programmed patterns to be selected. The device is powered by a rechargeable battery.

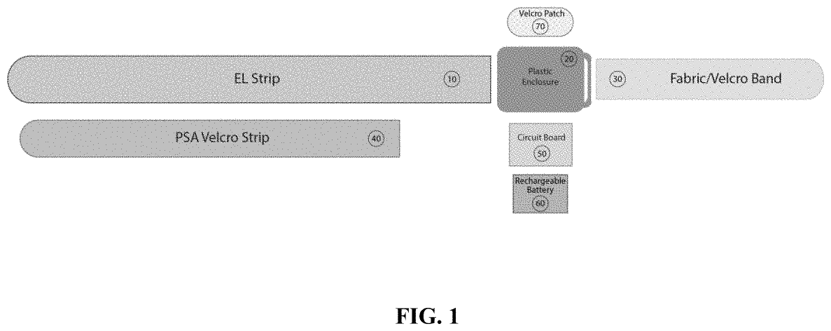

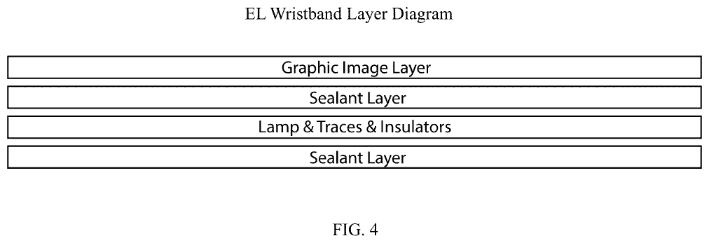

The exemplary wrist band illustrated in the FIG. 1 is made up of several components which cooperate with one another to produce the desired results. While variations are possible, these components generally include an enclosure 20 which is connected to an EL (electroluminescent) graphic band/strip 10 and a Velcro closure component 30 (i.e. a Velcro band). Contained within plastic closure 20 is a PCB assembly (i.e. integrated circuit) 50 and a rechargeable battery 60. In addition, an adhesive backed Velcro strip 40 is attached to the back side of EL graphic band 10, and a Velcro patch 70 is attached to the top side of plastic enclosure 20. As will be recognized, Velcro strip 40 and Velcro patch 70 will interact with Velcro band 30 to create wristband type structure. Although not specifically shown in FIG. 1, EL graphic band/strip 10 includes a base material, a number of electroluminescent lamps (also known simply as lamps) which are placed on the base material or a substrate of some type, a printed graphic image which is printed over the electroluminescent lamps and a protective coating. Those skilled in the art will recognize that various electroluminescent materials could be used, including various types of phosphors. FIG. 4 illustrates one example of a layer stack-up that can be used to form the display device. As shown, the layer stack-up comprises a graphic image layer, a first sealant layer, a lamp & trace & insulators layer and a second sealant layer make up. The graphic image layer is positioned at the top of the stack, which is a generally clear layer of material having graphic images printed on the bottom surface thereof. The first sealant layer is located below the graphic image layer and is used to couple and protect elements. The lamp & trace & insulator layer is positioned between first sealant layer and second sealant layer. This includes the electroluminescent lamps, electrical signal traces used to control illumination of the lamps, and appropriate insulators to control electrical current within the display device.

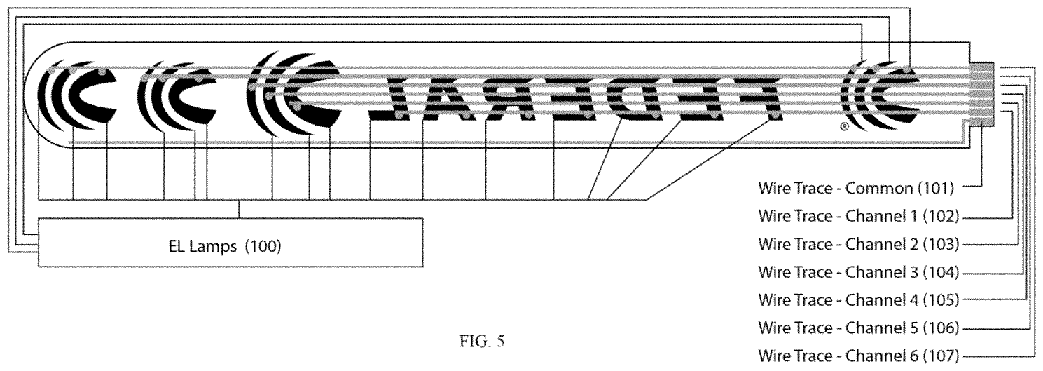

In one embodiment, there are many electroluminescent lamps positioned at desired locations on a base material, and each electroluminescent lamp is part of six different channels, wherein each lamp connected to a single channel is intended to be lit simultaneously. In this embodiment, each of the separate channels are capable of being separately illuminated. This general configuration is shown in FIG. 5, which illustrates an example of the EL graphic band 10, but illustrates various EL Lamps 100, and a number of wire traces. More specifically, a common wire trace 101 is used to provide a ground or feedback path for electrical current supplied to other components. Also shown are the six (6) channels electrically connected to EL lamps 100, including a channel 1 (102), a channel 2 (103), a channel 3 (104), a channel 4 (105), a channel 5 (106) and a channel 7 (108), which are all used to provide a unique graphic image display. In this example, powering channel 1 (102) will cause all of the letters on EL graphic band 10 to be illuminated, while the other channels are used to illuminate various graphic elements. Although not shown in FIG. 5, each channel will be electrically coupled to integrated circuit 50, which will control the sequence and timing of illumination.

Although a wristband embodiment of a display device is described above, those skilled in the art will recognize that the various components (i.e. a base material, electroluminescent circuits, printed graphics, protective coating, integrated circuit 50, etc.) can be configured to form many other devices such as ankle bands, belts, dog-collars, pendants, keychains, lanyards, necklaces, etc.

In the illustrated embodiment, it is contemplated that integrated circuit 50 is supported on a printed circuit board and is contained within enclosure 20, which is made of a plastic material. That said, it is equally possible that the circuit could be printed on a portion of graphic band 10 and could be physically protected using appropriate coatings. The physical structure and make-up of various components can vary depending on the particular application and related requirements.

The Electroluminescent graphic band (EL band) referenced above includes a combination of several electroluminescent lamps or sections that can be selectively illuminated. By providing unique designs for the electroluminescent tracks and controlling the manner or sequence of illumination, unique patterns, images and scenes can be created. These electroluminescent lamps or sections are formed by printing or depositing appropriate materials on a substrate.

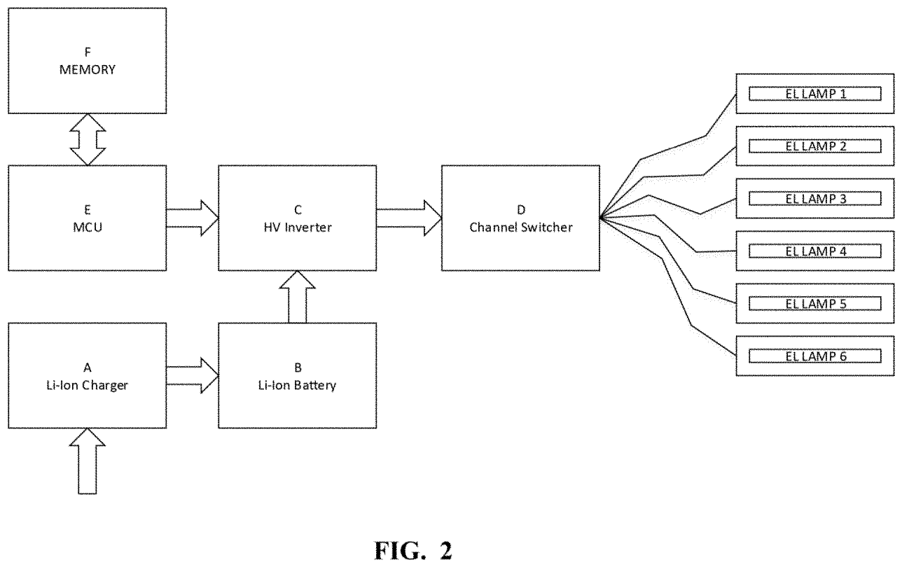

As shown in FIG. 1, a circuit board 50 is included as one part of the illuminated wristband. Additional detail regarding one embodiment of the circuitry supported by the circuit board is generally illustrated in FIG. 2. As a first component, a high-voltage (HV) inverter (C) is included which generates 250 VAC nominally by means of a high-efficiency relaxation oscillator and step-up transformer. The generated high-voltage is fed to a channel switcher (D) that directly drives the EL lamps segments. The switcher (D) is controlled by a microcontroller unit (E) in accordance with a preset program defined in memory (F). The power for the unit is obtained from a Li-Ion or Li—Po battery source (B) and may be charged from a standard power source from time-to-time using an appropriate USB cable and the built-in charger (A).

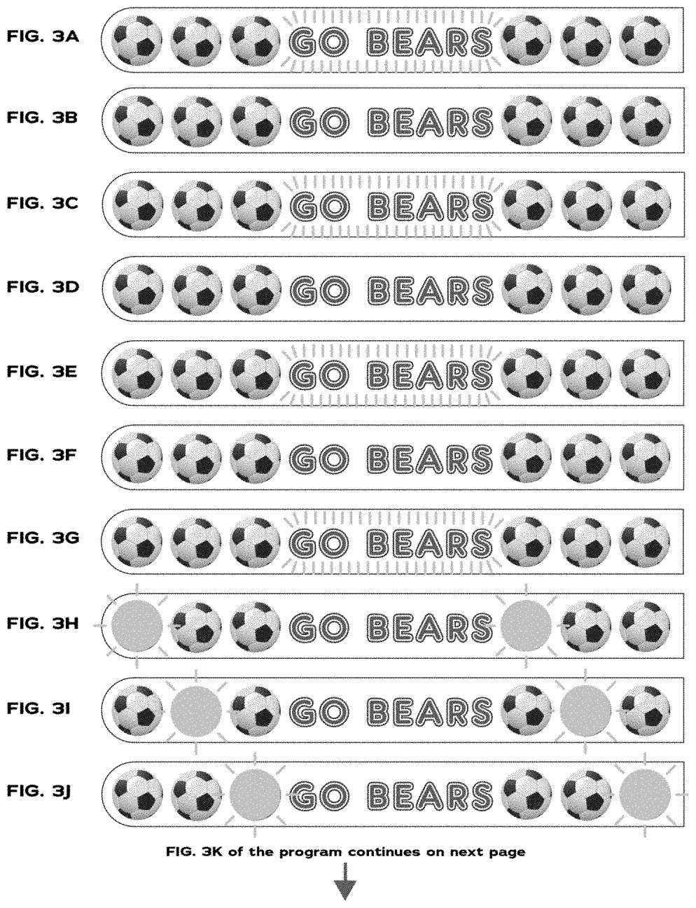

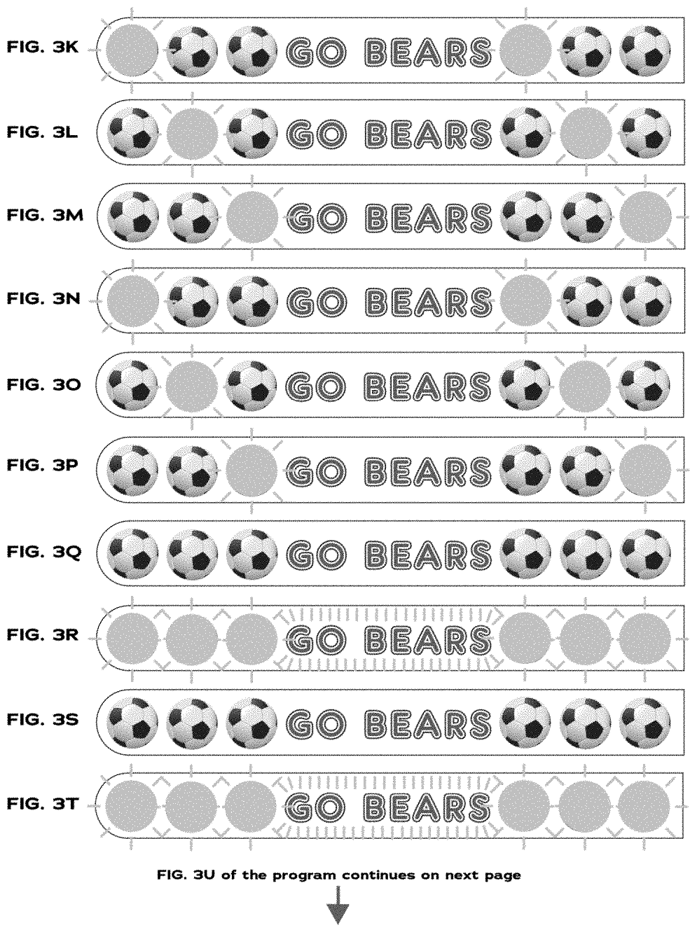

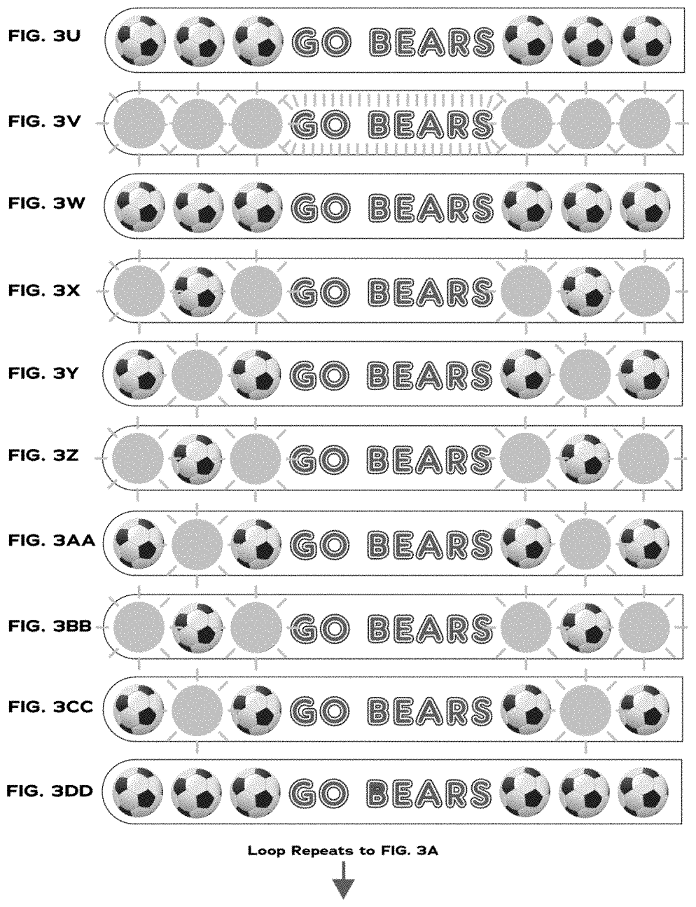

As suggested above, the various components of the wristband cooperate with one another to provide brand/event advertising, team building, group identity, entertainment, safety, visibility, and/or general levels of excitement. As further outlined in relation to FIGS. 3A-3DD, the various components are specifically configured to meet these goals.

To provide one example of how the present embodiment provides a unique promotional device, an example bracelet animation program is generally described below with regards to FIGS. 3A-3DD. As can be seen, this bracelet is configured to present a “GO BEARS” message, and to illuminate multiple soccer balls at desired times and in desired sequences. This example animation program shows one way to create excitement for a fan or produce a brand identity graphic for display to others. The programs are set up to turn the lamp segments on and off in a particular order and for specific amounts of time, thus providing the ability to produce a desired presentation. Due to the types of material making up the electroluminescent circuits and the capabilities of the controller used, the switching of segments can occur at a very rapid pace (e.g. less than 100 ms), which allows for considerable flexibility in the type of animation and graphic images that can be produced. The brightness of an individual channel at any point in the program may also be controlled. The programs of this example repeat in a constant loop until the device is turned off, or another program is selected.

In the example program of FIGS. 3A-3DD, the line or marking surrounding the “GO BEARS” text or a soccer ball indicates that those characters are illuminated. The control circuitry used to carry out the program is also capable of making the characters or images flash. For example, FIG. 3A illustrates a condition where “GO BEARS” is illuminated. FIG. 3B shows a condition where none of the characters or elements are illuminate. In this example, “GO BEARS” will be turned on and off three times (see e.g. FIGS. 3A-3F). Next, predetermined sets of soccer balls are illuminated. Referring to FIG. 3H, in this state the first and fourth soccer balls (from left to right) are illuminated. Next, the second and fifth soccer balls are illuminated, as shown in FIG. 3I, followed by the third and sixth being illuminated, as shown in FIG. 3J. As the program progresses, various combinations are illuminated to allow the desired graphic presentation.

In the example program shown in FIGS. 3A-3DD, it is contemplated that the controller will cause the wristband to change states at equally timed intervals. The timing of each “state” can vary depending on the desired presentation. Additionally, the brightness can be varied, as desired. Many different combinations are possible.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A portable electroluminescent display device, comprising:
a base structure;
an electroluminescent strip configured to be attachable to the base structure, the electroluminescent strip having a plurality of separate luminescent areas configured in predetermined shapes; and
a controller operably coupled to the electroluminescent strip and configured to provide illumination signals which cause the selective illumination of the plurality of separate luminescent areas in a predetermined manner to create a graphic presentation, the controller comprising a microcontroller, a memory, a battery and a driver to cause portions of the electroluminescent strip to be illuminated, wherein the memory will store instructions executable by the microcontroller to cause the driver to cause the selective illumination of the plurality of separate luminescent areas in the predetermined manner.

2. The portable electroluminescent display device of claim 1 wherein the base structure comprises a wrist band, ankle bracelet, pet collar, belt, clothing accessory, or pendant.

3. The portable electroluminescent display device of claim 1 wherein the selective illumination of the plurality of separate luminescent areas directed by the microcontroller will cause any one of the plurality of separate luminescent area to be illuminated for a period of time.

4. The portable electroluminescent display device of claim 1 wherein the selective illumination of the plurality of separate luminescent areas directed by the microcontroller will cause any one of the plurality of separate luminescent area to be illuminated for at a predetermined brightness.

5. The portable electroluminescent display device of claim 1 wherein the selective illumination of the plurality of separate luminescent areas directed by the microcontroller will cause a combination of selected ones of the plurality of separate luminescent area to be illuminated for a period of time.

6. The portable electroluminescent display device of claim 1 wherein the predetermined manner of illumination comprises a sequence of a plurality of illuminate states, and wherein the sequence will loop continuously.

7. The portable electroluminescent display device of claim 1 wherein the selective illumination of the plurality of separate luminescent areas directed by the microcontroller will cause any one of the plurality of separate luminescent area to be flash for a period of time.
